(19) United States
(12) Patent Application Publication
(10) Pub. No.: US 2013/0182406 A1
(43) Pub. Date: Jul. 18, 2013

(54) POLARIZED LIGHT SOURCE MODULE

(71) Applicants: Dongguan Masstop Liquid Crystal Display Co., Ltd., Dongguan City (CN); Wintek Corporation, Taichung City (TW)

(72) Inventors: Zhi-Ting Ye, Miaoli County (TW); Chin-Liang Chen, Taichung City (TW); Ming-Chuan Lin, Taichung City (TW); Chong-Yang Fang, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/740,274

(22) Filed: Jan. 14, 2013

(30) Foreign Application Priority Data
Jan. 18, 2012 (TW) 101101914

(51) Int. Cl. F21V 13/02; F21V 13/12

(52) U.S. Cl. CPC F21V 13/02; F21V 13/12
USPC 362/19

(57) ABSTRACT

A polarized light source module, having a first region and a second region adjacent to at least one edge of the first region, includes a lamp shell, at least one light source, a polarization generator, and a micro-structure layer. The light source is disposed in the second region. The polarization generator is disposed in the second region, and the polarization generator is used to polarize light generated from the light source. The micro-structure layer is disposed in the first region, and the micro-structure layer is used to reflect the light polarized by the polarization generator toward a direction away from the lamp shell.

### BACKGROUND OF THE INVENTION

1. Field of the Invention

The present invention relates to a luminescent device, and more particularly, to a polarized light source module capable of providing polarized light.

2. Description of the Prior Art

Light sources used in ordinary lighting devices generally include both light polarized along a vertical direction and light polarized along a horizontal direction. Discomfort glare may be accordingly generated when reading under the light source described above. The glare problem may be improved by polarizing light along a specific direction. Therefore, a polarized light source module capable of providing polarized light is developed to enhance the reading quality.

Please refer to FIG. 1 and FIG. 2. FIG. 1 is a schematic diagram illustrating a lateral view of a conventional polarized light source module. FIG. 2 is a schematic diagram illustrating a top-view of the conventional polarized light source module. As shown in FIG. 1 and FIG. 2, a conventional polarized light source module 900 includes a lamp shell 910, a plurality of light emitting diode light sources 920, a light controlling structure 930, and a polarizing film 940. The light emitting diode light sources 920 are generally disposed uniformly on an inner surface 910S of the lamp shell 910. The light controlling structure 930 is used to guide a light 920L generated from the light emitting diode light sources 920 to a predetermined direction so as to enhance brightness in the predetermined direction. The polarizing film 940 is used to polarize the light 920L. The light 920L may then become a polarized light 920P. The size of the polarizing film 940 has to be adjusted according to the amount and the allocation of the light emitting diode light sources 920 so as to cover all the light emitting diode light sources 920 and the polarized light source module 900 may then generate a polarized planar light source. However, polarizing films with greater brightness enhancement are generally more expensive. The cost of the polarizing film may become too high in the polarized light source module which has to provide polarized planar light source in large area. The product competitiveness of the conventional polarized light source module 900 may be accordingly affected.

### SUMMARY OF THE INVENTION

It is one of the objectives of the present invention to provide a polarized light source module. An edge type light source and a micro-structure layer are employed in the polarized light source module to generate a polarized planar light source. A size of a polarization generator required in the polarized light source module may therefore become smaller, and the purposes of thinner design and cost reduction may accordingly be achieved.

To achieve the purposes described above, a preferred embodiment of the present invention provides a polarized light source module. The polarized light source module has a first region and a second region adjacent to the first region. The polarized light source module includes a lamp shell, at least one light source, a polarization generator, and a micro-structure layer. The light source is disposed in the second region. The polarization generator is disposed in the second region, and the polarization generator is used to polarize light generated from the light source. The micro-structure layer is disposed in the first region, and the micro-structure layer is used to reflect the light polarized by the polarization generator toward a direction away from the lamp shell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a lateral view of a conventional polarized light source module.

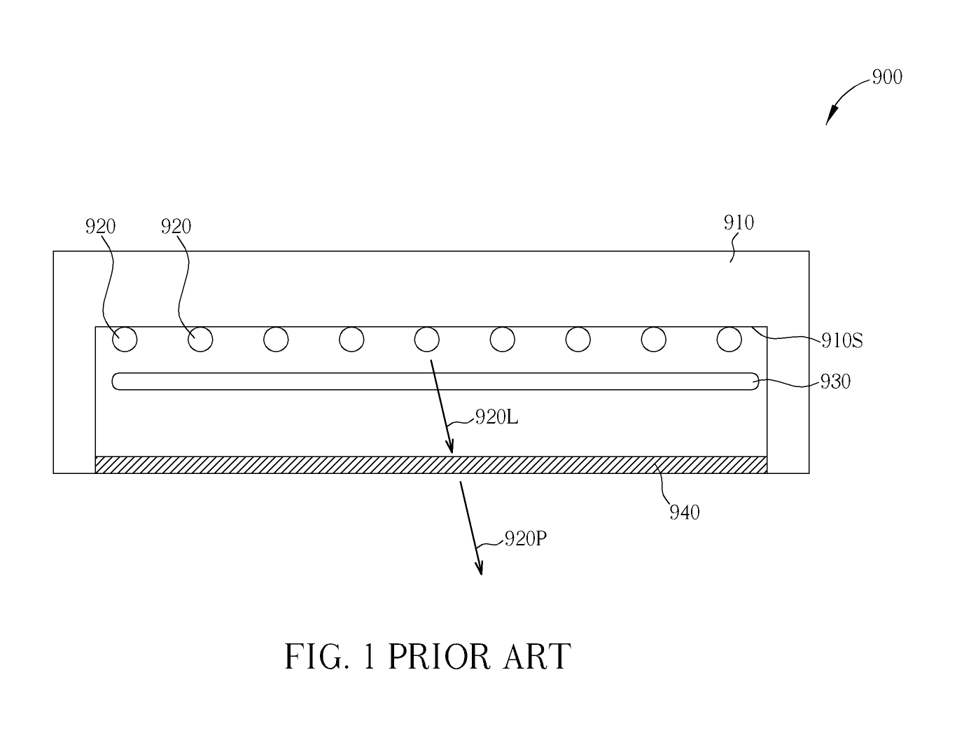

FIG. 2 is a schematic diagram illustrating a top-view of a conventional polarized light source module.

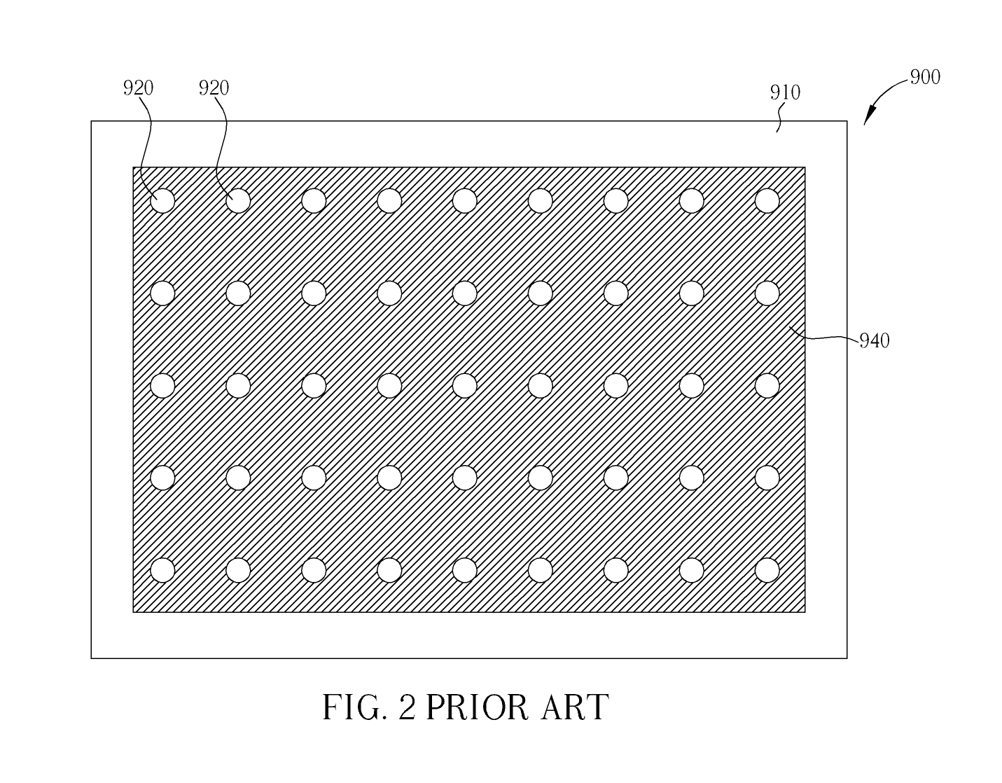

FIG. 3 is a schematic diagram illustrating a top-view of a polarized light source module according to a first preferred embodiment of the present invention.

FIG. 4 is a schematic diagram illustrating a lateral view of a polarized light source module according to the first preferred embodiment of the present invention.

FIG. 5 is a schematic diagram illustrating a polarized light source module according to a second preferred embodiment of the present invention.

FIG. 6 is a schematic diagram illustrating a polarized light source module according to a third preferred embodiment of the present invention.

### DETAILED DESCRIPTION

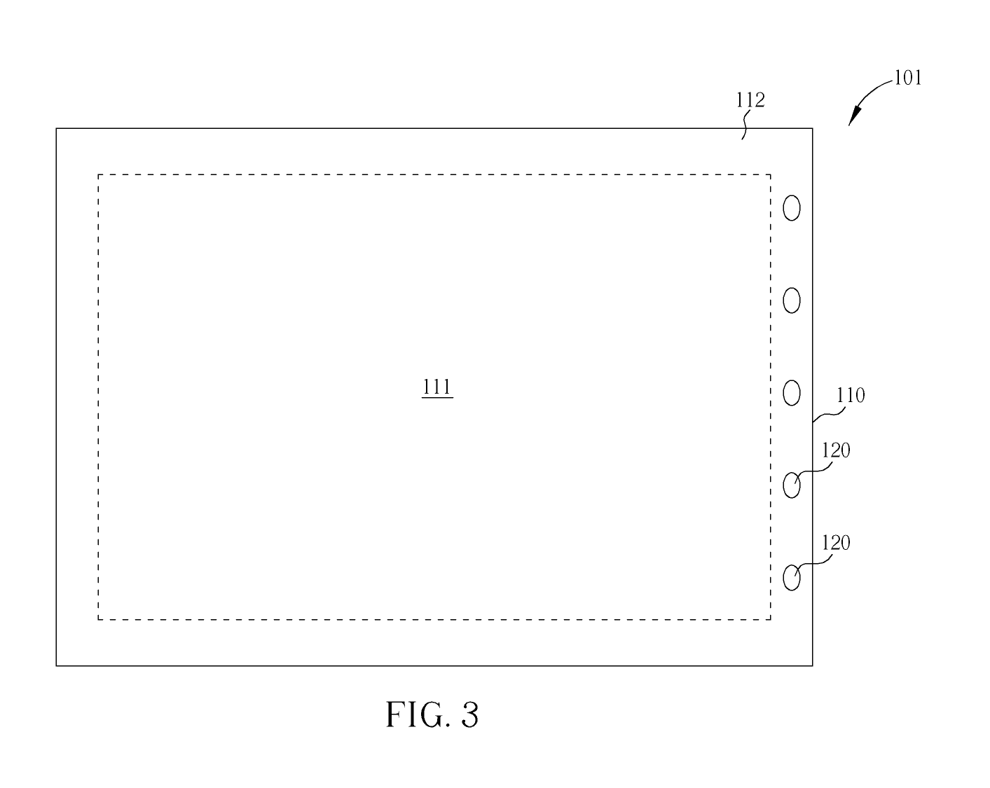

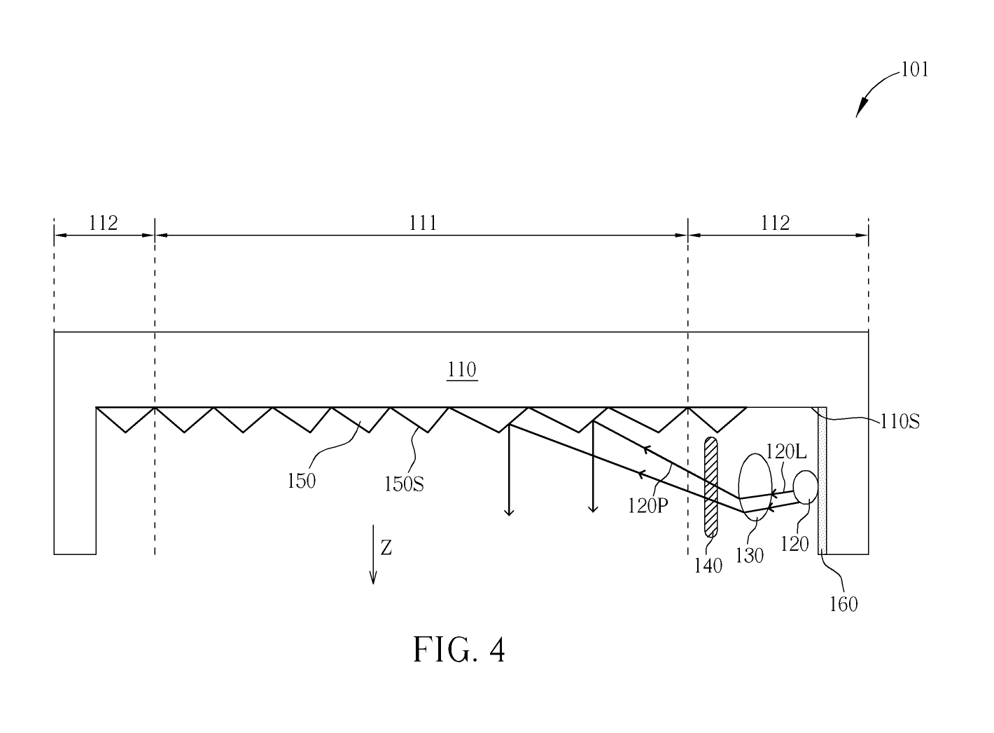

Please refer to FIG. 3 and FIG. 4. FIG. 3 is a schematic diagram illustrating a top-view of a polarized light source module according to a first preferred embodiment of the present invention. FIG. 4 is a schematic diagram illustrating a lateral view of the polarized light source module according to the first preferred embodiment of the present invention. Please note that the figures are only for illustration and the figures may not be to scale. The scale may be further modified according to different design considerations. As shown in FIG. 3 and FIG. 4, the first preferred embodiment of the present invention provides a polarized light source module 101. The polarized light source module 101 has a first region 111 and a second region 112 adjacent to the first region 111. The first region 111 may be a central region, and the second region 112 may be a peripheral region adjacent to at least one edge of the first region 111. In this embodiment, the second region 112 surrounds the first region 111, but the present invention is not limited to this. In other preferred embodiments of the present invention, the second region 112 may only be adjacent to a part of the edges of the first region 111. The polarized light source module 101 includes a lamp shell 110, at least one light source 120, a polarization generator 140, and a micro-structure layer 150. The light source 120 is disposed in the second region 112. The polarization generator 140 is disposed in the second region 112 so as to polarize the light 120L generated from the light source 120. The micro-structure layer 150 is disposed in the first region 111 so as to reflect light polarized by the polarization generator 140 toward a direction Z away from the lamp shell 110. In other words, in this embodiment, the polarization generator 140 may be used to polarize the light 120L generated from the light source 120, and the micro-structure layer 150 may be used to reflect the light polarized by the polarization generator 140 toward the direction Z away from the lamp shell 110. Additionally, in this embodiment, the polarized light source module 101 may further include a light controlling structure 130 disposed between the light source 120 and the polarization generator 140 so as to guide the light 120L generated from the light source 120 to the polarization generator 140 and the micro-structure layer 150. In other words, the light controlling structure 130 in this embodiment may be used to guide the light 120L generated from the light source 120 to the polarization generator 140 and the micro-structure layer 150, but not limited thereto. More specifically, the light 120L generated from the light source 120 may be guided toward a direction pointing at the polarization generator 140 and the micro-structure layer 150 after passing the light controlling structure 130. The light 120L may be polarized to be a polarized light 120P after passing the polarization generator 140. The polarized light 120P may be reflected by the micro-structure layer 150 toward the direction Z away from the lamp shell 110. The light 120L generated by the light source 120 may be guided by the light controlling structure 130 toward the polarization generator 140 to get polarized. The polarized light 120P guided to each parts of the micro-structure layer 150 may be respectively reflected by the micro-structure layer 150 toward the direction Z away from the lamp shell 110 and a polarized planar light source may be accordingly generated. In other words, based on the structure of the polarized light source module 101 described above, the light source 120 in the second region 112, which may be regarded as a kind of edge type light source, may be employed to provide light, and a polarized planar light source may be generated by employing different kinds of micro-structures on the micro-structure layer 150 and a smaller sized polarization generator 140. The manufacturing cost of the polarized light source module 101 may be accordingly reduced. It is worth noting that a tilt angle of the polarization generator 140 in this embodiment may be further modified based on different design considerations. A surface of the polarization generator 140 is preferably not parallel to a bottom surface 110S of the lamp shell, but not limited thereto. The polarization generator 140 is preferably disposed only in the second region 112. The micro-structure layer 150 is disposed in the first region 111, and the micro-structure layer 150 may also extend to at least a part of the second region 112 so as to generate a better light guiding effect. In this embodiment, the light source 120, the light controlling structure 130, and the polarization generator 140 may be sequentially disposed from an outer part to an inner part of the second region 112 so as to generate better optical performances, but the present invention is not limited thereto and the allocation of the light controlling structure 130 may be modified according to different considerations. For example, the light source 120, the polarization generator 140, and a light controlling structure may be sequentially disposed from the outer part to the inner part of the second region 112 so as to generate different optical performances in other preferred embodiment of the present invention. In addition, the polarized light source module 101 in this embodiment may be used in lighting, in backlight sources of display devices, or in other devices requiring polarized light source.

In this embodiment, the light controlling structure 130 may preferably include a light controlling lens or other appropriate light controlling structures so as to effectively guide the light generated from the light source 120 toward the direction pointing at the polarization generator 140 and the micro-structure layer 150. Additionally, the polarization generator 140 may preferably include a polarizing film, a brightness enhancement film (BEF) or a dual brightness enhancement film (DBEF), but the present invention is not limited to this and other kinds of polarization generators may also be employed in the present invention to polarize the light and enhance the brightness. The light source 120 may preferably include a light emitting diode (LED), a cold cathode fluorescent lamp (CCFL), or other appropriate light sources. As shown in FIG. 4, the micro-structure layer 150 in this embodiment is preferably a V-cut micro-structure layer and a surface 150S of the micro-structure layer 150 is preferably a specular reflection surface so as to effectively reflect the polarized light 120P toward the direction Z away from the lamp shell 110. Additionally, the micro-structure layer 150 in this embodiment preferably has no effect on the polarization of the polarized light 120P. It is worth noting that the light controlling structure 130 and the design of the micro-structure layer 150 may be further modified to adjust the direction of the polarized light 120P reflected by the micro-structure layer 150 and the illumination effect of the polarized light 120P may then be adjusted to different desired directions. In addition, the polarized light source module 101 in this embodiment may further include a reflecting layer 160 disposed between the lamp shell 110 and the light source 120. The reflecting layer 160 may be used to reflect the light that is not emitted directly to the light controlling structure 130, and another polarized light filtered by the polarization generator 140 may also be recycled by the reflecting layer 160. The luminous efficacy of the polarized light source module 101 may be accordingly enhanced. It is worth noting that, as shown in FIG. 3, the polarized light source module 101 may include a plurality of the light sources 120. The light sources 120 are preferably disposed and aligned on one edge of the polarized light source module 101, but the present invention is not limited to this. In other preferred embodiments of the present invention, the light sources 120 that are accompanied with polarization generators and light controlling structures may be disposed in the second region 112 and aligned on two opposite edges or all the edges of the polarized light source module 101 so as to further enhance the brightness of the polarized planar light source 101.

The following description will detail the different embodiments of the polarized light source module of the present invention. To simplify the description, identical components in each of the following embodiments are marked with identical symbols. For making it easier to understand the differences between the embodiments, the following description will detail the dissimilarities among different embodiments and the identical features will not be redundantly described.

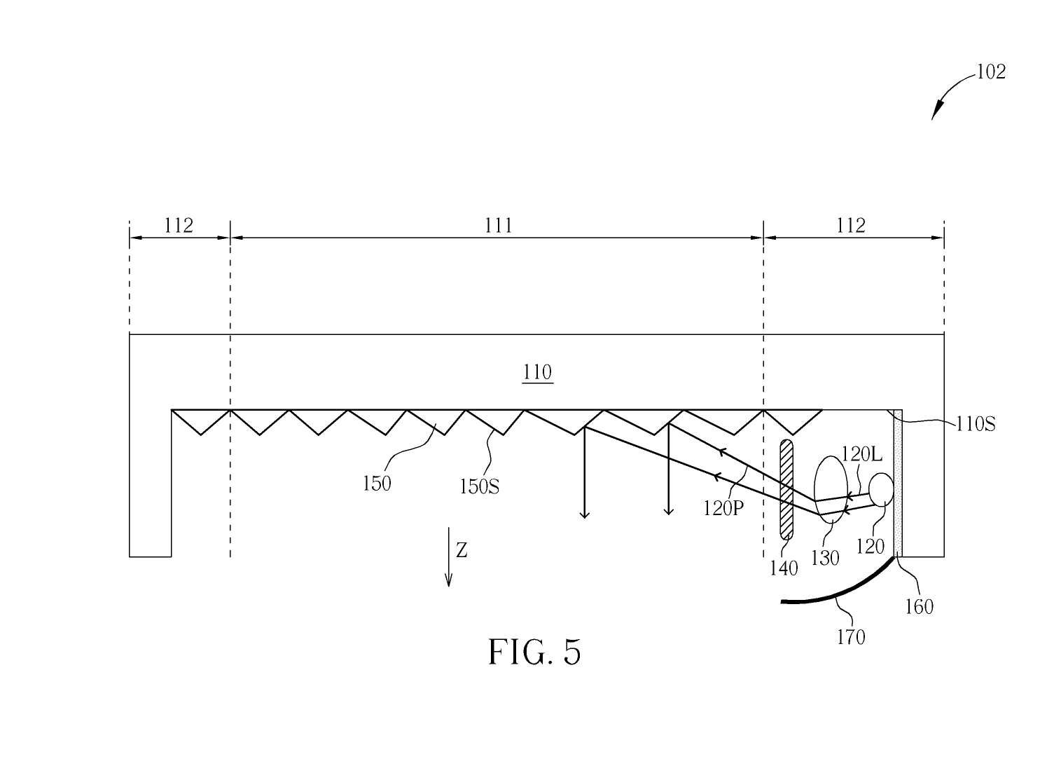

Please refer to FIG. 5. FIG. 5 is a schematic diagram illustrating a polarized light source module according to a second preferred embodiment of the present invention. As shown in FIG. 5, the difference between a polarized light source module 102 of this embodiment and the polarized light source module 101 of the first preferred embodiment is that the polarized light source module 102 further includes a reflecting shield 170 disposed to be adjacent to the lamp shell 110. The reflecting shield 170 may be used to shield light which is not guided to the micro-structure layer 150. Additionally, similarly to the reflecting layer 160, the reflecting shield 170 may also be used to reflect the light that is not emitted directly to the light controlling structure 130, and another polarized light filtered by the polarization generator 140 may also be recycled by the reflecting shield 170. The luminous efficacy of the polarized light source module 102 may be accordingly enhanced. Apart from the reflecting shield 170 in this embodiment, the other components, allocations, and material properties of the polarized light source module 102 in this embodiment are similar to those of the polarized light source module 101 in the first preferred embodiment detailed above and will not be redundantly described.

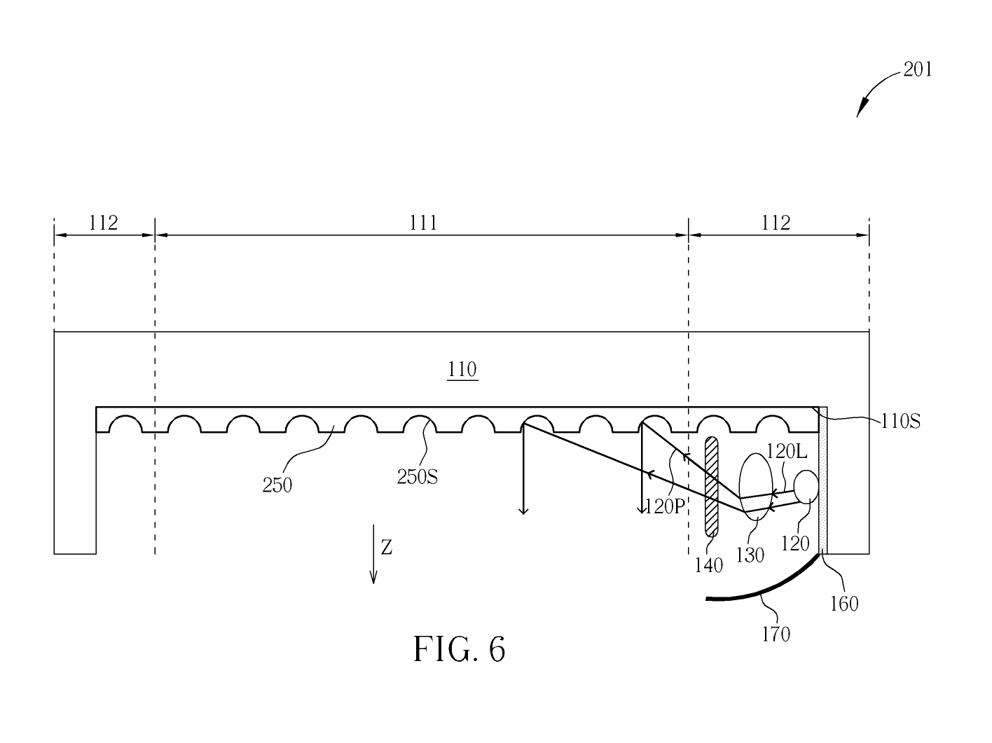

Please refer to FIG. 6. FIG. 6 is a schematic diagram illustrating a polarized light source module according to a third preferred embodiment of the present invention. As shown in FIG. 6, the difference between a polarized light source module 201 of this embodiment and the polarized light source module 102 of the second preferred embodiment is that the polarized light source module 201 includes a micro-structure layer 250. The micro-structure layer 250 is preferably an R-cut micro-structure layer, and a surface 250S of the micro-structure layer 250 is preferably a specular reflection surface so as to effectively reflect the polarized light 120P toward the direction Z away from the lamp shell 110. Additionally, the micro-structure layer 250 in this embodiment preferably has no effect on the polarization of the polarized light 120P so as to ensure the quality of the polarized planar light source provided by the polarized light source module 201. Apart from the micro-structure layer 250 in this embodiment, the other components, allocations, and material properties of the polarized light source module 201 in this embodiment are similar to those of the polarized light source module 102 in the second preferred embodiment detailed above and will not be redundantly described.

To summarize the above descriptions, the polarized light source module in the present invention is used to provide a polarized planar light source and may accordingly be employed in lighting without glare problems, in backlight sources of display devices, or in other devices requiring polarized light source. In the present invention, the polarized light may be generated by the light source and the polarization generator disposed in the second region of the polarized light source module, and the polarized light may be reflected by the micro-structure layer to form a polarized planar light source. The size of the required polarization generator may therefore be smaller, and the purposes of thinner design and cost reduction may accordingly be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polarized light source module, having a first region and a second region adjacent to the first region, the polarized light source module comprising:
a lamp shell;
at least one light source, disposed in the second region;
a polarization generator, disposed in the second region, wherein the polarization generator is used to polarize light generated from the light source; and
a micro-structure layer, disposed in the first region, wherein the micro-structure layer is used to reflect the light polarized by the polarization generator toward a direction away from the lamp shell.

2. The polarized light source module of claim 1, wherein the first region is a central region, and the second region is a peripheral region adjacent to at least one edge of the first region.

3. The polarized light source module of claim 1, further comprising a light controlling structure, disposed between the light source and the polarization generator, wherein the light controlling structure is used to guide the light generated from the light source to the polarization generator and the micro-structure layer.

4. The polarized light source module of claim 3, wherein the light controlling structure comprises a light controlling lens.

5. The polarized light source module of claim 1, wherein the polarization generator comprises a polarizing film, a brightness enhancement film (BEF) or a dual brightness enhancement film (DBEF).

6. The polarized light source module of claim 1, wherein the micro-structure layer comprises a V-cut micro-structure layer or an R-cut micro-structure layer.

7. The polarized light source module of claim 1, wherein a surface of the micro-structure layer is a specular reflection surface.

8. The polarized light source module of claim 1, further comprising a reflecting layer, disposed between the lamp shell and the light source.

9. The polarized light source module of claim 1, further comprising a reflecting shield, disposed to be adjacent to the lamp shell.

10. The polarized light source module of claim 1, wherein the light source comprises a light emitting diode (LED) or a cold cathode fluorescent lamp (CCFL).
